(19) United States
(12) Patent Application Publication
(10) Pub. No.: US 2026/0171672 A1
(43) Pub. Date: Jun. 18, 2026

(54) ELECTRIC-FIELD RESONANCE ANTENNA AND POWER TRANSMISSION APPARATUS

(71) Applicant: NTT, Inc., Tokyo (JP)

(72) Inventor: Takanori WASHIRO, Tokyo (JP)

(21) Appl. No.: 19/129,215

(22) PCT Filed: Nov. 25, 2022
(86) PCT No.: PCT/JP2022/043606

§ 371 Date: May 12, 2025

(51) Int. Cl. H01Q 9/30; H01Q 9/16; H02J 50/05; H02J 50/23

(52) U.S. Cl. CPC H01Q 9/30; H01Q 9/16; H02J 50/05; H02J 50/23

(57) ABSTRACT

An object of the present disclosure is to suppress damage to an electric field resonance antenna. Therefore, the present disclosure provides an electric field resonance antenna including: a resonance unit that includes a first spherical electrode, a second spherical electrode, and a resonance coil connecting the first spherical electrode and the second spherical electrode, and resonates at an output frequency of a power transmission-reception circuit for power transmission; and a power supply unit including a power supply coil magnetically coupled to the resonance coil and electrically connected with the power transmission-reception circuit.

### TECHNICAL FIELD

The present disclosure relates to an electric field resonance antenna and a power transmission apparatus.

### BACKGROUND ART

In a system in which two pairs of electrodes face each other and electric power is transmitted in a non-contact manner using capacitive coupling between the electrodes, transmission efficiency rapidly decreases as a distance between the electrodes increases. Therefore, an electric field resonance system that uses resonance between a transmitting antenna and a receiving antenna is adopted in order to perform wireless power transmission over a relatively long distance (refer to Non-Patent Literature 1).

### CITATION LIST

### Non-Patent Literature

Non-Patent Literature 1:“Electric Field Resonant Antenna for Wireless Power Transfer Based on Infinitesimal Dipole” IEEE Wireless Power Transfer Conference (WPTC2021)

### SUMMARY OF INVENTION

### Technical Problem

However, a voltage applied between the electrodes of the electric field resonance antenna in the resonant state reaches several tens to several hundreds of times the input voltage, and there arises a problem that the electric field antenna is damaged.

The present invention has been made to solve the above-described problem, and an object thereof is to suppress damage to an electric field resonance antenna.

### Solution to Problem

In order to solve the above problem, an invention according to claim 1 is an electric field resonance antenna including: a resonance unit that includes a first spherical electrode, a second spherical electrode, and a resonance coil connecting the first spherical electrode and the second spherical electrode, and resonates at an output frequency of a power transmission-reception circuit for power transmission; and a power supply unit that includes a power supply coil magnetically coupled to the resonance coil and electrically connected with the power transmission-reception circuit.

### Advantageous Effects of Invention

As described above, according to the present invention, it is possible to suppress damage to an electric field resonance antenna.

### BRIEF DESCRIPTION OF DRAWINGS

FIG. 1 is a perspective view of a power transmission apparatus according to a first premise technique.

FIG. 2 is a perspective view of an electric field antenna for power transmission constituting part of a power transmission apparatus according to a second premise technique.

FIG. 3(a) is a view illustrating a distribution of standing waves of a voltage and a current, and FIG. 3(b) is a perspective view of an electric field antenna corresponding to FIG. 3(a).

FIG. 4 is a perspective view of the power transmission apparatus according to the second premise technique.

FIG. 5 is a diagram illustrating lines of electric force generated by the electric field antenna for power transmission constituting part of the power transmission apparatus according to the second premise technique.

FIG. 6 is a plan view of an electric field resonance antenna constituting part of a power transmission apparatus according to a first embodiment.

FIG. 7 is a perspective view of the electric field resonance antenna constituting part of the power transmission apparatus according to the first embodiment.

FIG. 8 is a perspective view of an electric field resonance antenna constituting part of a power transmission apparatus according to a second embodiment.

### DESCRIPTION OF EMBODIMENTS

### Techniques as Premise for Development of Apparatuses of Present Embodiments

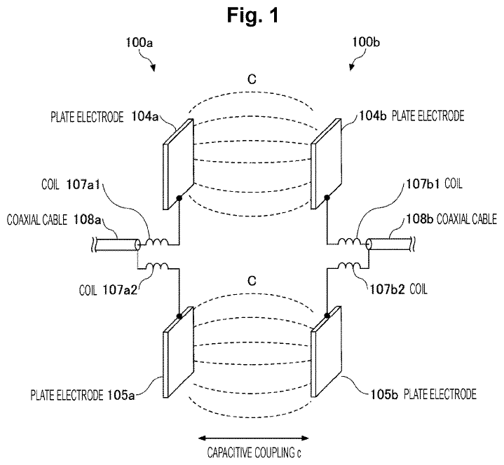

First, techniques as a premise of development of apparatuses of the present embodiments will be described with reference to FIGS. 1 to 6.

### First Premise Technique

First, a power transmission apparatus according to a first premise technique will be described with reference to FIG. 1. FIG. 1 is a perspective view of the power transmission apparatus according to the first premise technique.

The power transmission apparatus of the first premise technique includes two (a pair of) electric field antennas, that is, an electric field antenna 100a for power transmission and an electric field antenna 100b for power reception.

In the electric field antenna 100a, two plate electrodes 104a and 105a are respectively coupled to plate electrodes 104b and 105b of the electric field antenna 100b, and accumulated positive and negative charges are alternately exchanged at a high frequency, thereby transmitting electric power to the right side of the drawing.

The plate electrode 104 is connected with a coil 107a1, and the plate electrode 105a is connected with a coil 107a2. A coaxial cable 108a is electrically connected with each of the coils 107a1 and 107a2, and plays a role of causing a current to flow to each of the coils 107a1 and 107a2 or causing a current from each of the coils 107a1 and 107a2 to flow.

Note that the configurations of the electric field antenna 100b for power reception are shown only by changing the tails of signs of the configurations of the electric field antenna 100a for power transmission from a to b, and each configuration is similar to that of the electric field antenna 100a, and thus the description thereof will be omitted.

As a result, the power transmission apparatus according to the first premise technique can cause the two pairs of plate electrodes (104a and 105a; 104b and 105b) to face, so as to transmit electric power in a non-contact manner using capacitive coupling c between the electrodes. In order to increase the capacitance (C) between the plate electrodes, it is desirable that the plate electrodes 104a and 105a are formed of flat plate shapes having as large an area as possible toward the plate electrodes 104b and 105b which the plate electrodes 104a and 105a face. An LC resonance circuit includes a capacitor formed by capacitive coupling c between the plate electrodes 104a and 104b (105a and 105b) and an inductor installed in the electric field antennas 100a and 100b, and is designed to increase transmission efficiency. However, when the direction of any one of the electric field antennas 100a and 100b is changed or the distance between the electric field antennas 100a and 100b increases, the capacitance between the electrodes decreases, and the transmission efficiency deteriorates. A technique devised in this regard is a second premise technique described below.

### Second Premise Technique

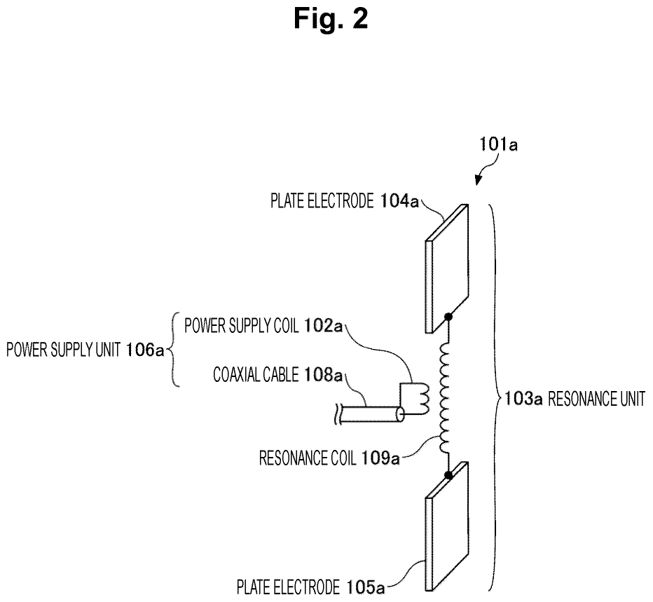

A power transmission apparatus according to the second premise technique will be described with reference to FIGS. 2 to 5. The power transmission apparatus according to the second premise technique is an apparatus that wirelessly transmits electric power by causing resonance units that resonate at a specific frequency to resonate with each other through a wave of an electric field propagating in the air.

As illustrated in FIG. 2, an electric field resonance antenna 101a for power transmission constituting part of the power transmission apparatus according to the second premise technique includes a resonance unit 103a that resonates at a certain specific frequency, and a power supply unit 106a for inputting electric power to the resonance unit 103a or taking out electric power from the resonance unit 103a that resonates.

The resonance unit 103a mainly includes a plate electrode 104a, a plate electrode 105a, and a resonance coil 109a. The resonance coil 109a is electrically connected with the plate electrode 104a and the plate electrode 105a and is located between the plate electrode 104a and the plate electrode 105a. The resonance unit 103a is designed to connect the two plate electrodes 104a and 105a with the resonance coil 109a interposed therebetween and to have an electrical length of ½ wavelength as a whole.

The power supply unit 106a mainly includes a power supply coil 102a and a coaxial cable 108a. The power supply coil 102a is magnetically coupled to the resonance coil 109a of the resonance unit 103a to input and output electric power to and from the resonance unit 103a. The coaxial cable 108a is electrically connected with the power supply coil 102a, and plays a role of causing a current to flow to the resonance coil 109a or causing a current from the resonance coil 109a to flow. A side of the coaxial cable 108a opposite to the power supply coil 102a is electrically connected with a power transmission-reception circuit.

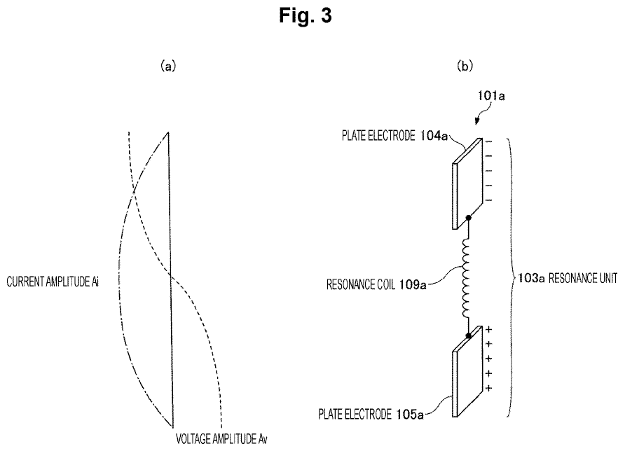

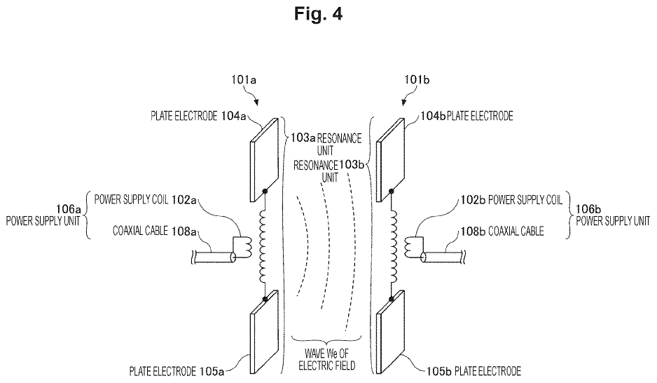

FIG. 3(a) is a diagram illustrating a distribution of standing waves of a voltage and a current, and FIG. 3(b) is a perspective view of an electric field antenna corresponding to FIG. 3(a). FIG. 4 is a perspective view of the power transmission apparatus according to the second premise technique. Note that, in FIG. 4, the power transmission apparatus of the second premise technique includes two (a pair of) electric field resonance antennas, that is, the electric field resonance antenna 101a for power transmission and an electric field resonance antenna 101b for power reception. The configurations of the electric field resonance antenna 101b for power reception are shown only by changing the tails of signs of the configurations of the electric field resonance antenna 101a for power transmission from a to b, and each configuration is similar to that of the electric field resonance antenna 101a, and thus the description thereof will be omitted.

As illustrated in FIG. 3(a), the resonance unit 103a of the electric field resonance antenna 101a illustrated in FIG. 3(b) resonates in a manner such that the voltage amplitude Av is maximized at both ends and the current amplitude Ai is maximized at the center. At this time, electric charges having opposite signs and the same magnitude are accumulated in the two plate electrodes 104a and 105a to form an electric dipole, and the electric dipole forms a wave We of an electric field in the periphery as illustrated in FIG. 4. The wave We of the electric field propagates in the air and reaches the electric field resonance antenna 101b for power reception, and a resonance unit 103b of the electric field resonance antenna 101b resonates with the wave of the electric field, so that wireless power transmission can be performed over a relatively long distance with high efficiency (refer to Non-Patent Literature 1).

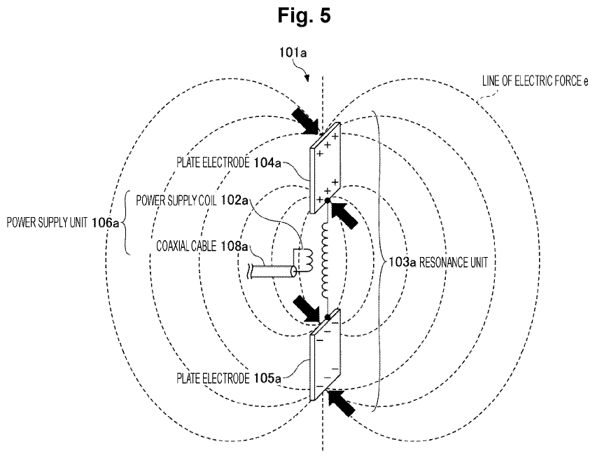

FIG. 5 is a diagram illustrating lines of electric force formed by the electric field antenna for power transmission constituting part of the power transmission apparatus according to the second premise technique.

As illustrated in FIG. 5, electric charges accumulated in the plate electrodes 104a and 105a of the electric field resonance antenna 101a are concentrated on edges of the plate electrodes 104a and 105a, and lines of electric force e are also concentrated on edges of the plate electrodes 104a and 105a. Since the field intensity is proportional to the density of the lines of electric force e, it can be seen that a strong electric field is locally generated at edges (portions indicated by black arrows) of the plate electrodes 104a and 105a. In particular, since a voltage of several tens to several hundreds of times the input power is applied to the resonance unit 103a of the electric field resonance antenna 101a due to resonance, there arises a problem that the electric field resonance antenna 101a is damaged due to dielectric breakdown when the field intensity exceeds a certain limit. A technique devised in this regard is a technique according to the present embodiments described below.

### Technique According to Present Embodiments

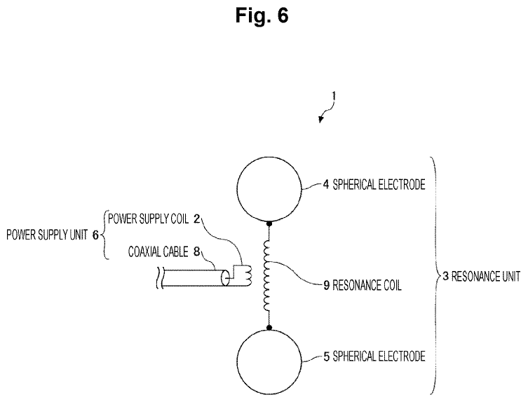

Hereinafter, power transmission apparatuses according to the present embodiments will be described with reference to FIGS. 6 to 8.

### First Embodiment

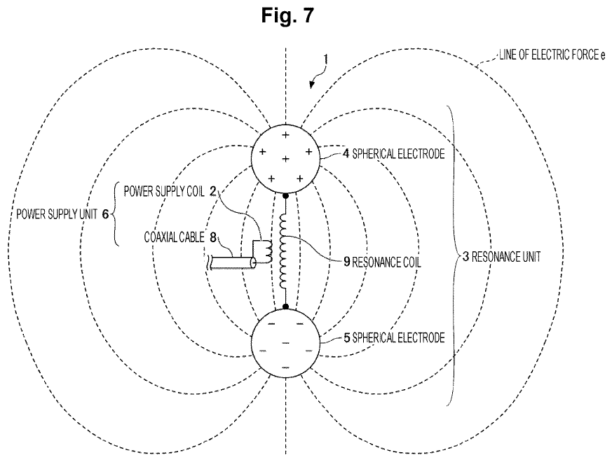

First, a first embodiment will be described with reference to FIGS. 6 and 7.

FIG. 6 is a plan view of an electric field resonance antenna constituting part of a power transmission apparatus according to the first embodiment. Note that the electric field resonance antenna illustrated in FIG. 6 may be used for power transmission or power reception. The power transmission apparatus according to the first embodiment has a configuration in which two (a pair of) electric field resonance antennas 1, one of which is illustrated in FIG. 6, face each other as illustrated in FIG. 4.

The power transmission apparatus according to the first embodiment is an apparatus that wirelessly transmits electric power by causing resonance units that resonate at a specific frequency to resonate with each other through a wave of an electric field propagating in the air.

As illustrated in FIG. 6, the electric field resonance antenna 1 for power transmission or power reception constituting part of the power transmission apparatus according to the first embodiment includes a resonance unit 3 that resonates at a certain specific frequency, and a power supply unit 6 for inputting electric power to the resonance unit 3 or taking out electric power from the resonance unit 3 that resonates.

The resonance unit 3 mainly includes a spherical electrode 4, a spherical electrode 5, and a resonance coil 9. The resonance coil 9 is electrically connected with the spherical electrode 4 and the spherical electrode 5 and is located between the spherical electrode 4 and the spherical electrode 5. The resonance unit 3 is designed to connect the two spherical electrodes 4 and 5 with the resonance coil 9 interposed therebetween and to have an electrical length of ½ wavelength as a whole.

The power supply unit 6 mainly includes a power supply coil 2 and a coaxial cable 8. The power supply coil 2 is magnetically coupled to the resonance coil 9 of the resonance unit 3 to input and output electric power to and from the resonance unit 3. The coaxial cable 8 is electrically connected with the power supply coil 2, and plays a role of causing a current to flow to the resonance coil 9 or causing a current from the resonance coil 9 to flow. A side (left side in FIG. 6) of the coaxial cable 8 opposite to the power supply coil 2 is electrically connected with a power transmission-reception circuit.

FIG. 7 is a perspective view of the electric field resonance antenna constituting part of the power transmission apparatus according to the first embodiment.

According to the electric field resonance antenna 1, as illustrated in FIG. 7, electric charges are evenly distributed on the surfaces of the spherical electrodes 4 and 5, so that the lines of electric force e are not biased, the field intensity is uniform, and the electric field does not become locally strong. Therefore, it is possible to create a wireless power transmission apparatus that is less likely to be damaged.

As described above, according to the present embodiment, the electric field resonance antenna 1 that performs wireless power transmission with high transmission efficiency by resonance can make the distribution of electric charges on the electrodes uniform, suppress local generation of a high voltage, and be less likely to be damaged.

Moreover, wireless power transmission can be performed to a distant place with high efficiency by storing more electric charges in the spherical electrodes 4 and 5 and generating a wave of a strong electric field.

Furthermore, the distribution of the wave of the electric field that transmits power in the periphery of the electric field resonance antenna 1 is uniform, and the transmission efficiency is less likely to change greatly even if the relative position of the electric field resonance antenna for power transmission or power reception deviates in the lateral direction.

Note that the current enters only to the skin depth of the metal surface at a high frequency, and thus the inside of the spherical electrodes 4 and 5 may be hollow. The intensity of the wave of the electric field is proportional to the amount of electric charges accumulated in the electrodes, regardless of the shape of the electrodes. Therefore, in the case of the spherical electrodes 4 and 5 having a large surface area, more electric charges are accumulated than in the electric field resonance antenna 101a having the plate electrodes 104a and 105a, and a wave We of a stronger electric field is generated, so that high transmission efficiency can be obtained.

### Second Embodiment

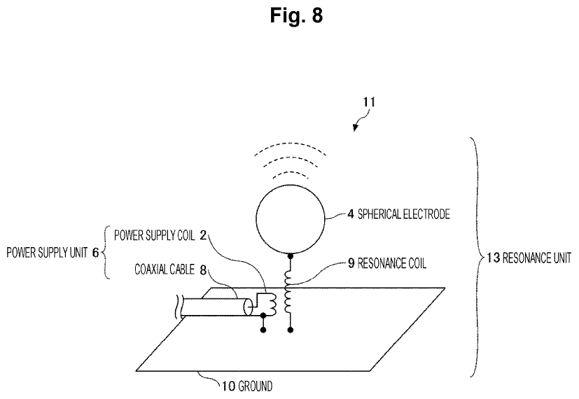

Next, a second embodiment will be described with reference to FIG. 8.

FIG. 8 is a perspective view of an electric field resonance antenna 11 constituting part of a power transmission apparatus according to the second embodiment. Note that the electric field resonance antenna illustrated in FIG. 8 may be used for power transmission or power reception. The power transmission apparatus according to the second embodiment has a configuration in which two (a pair of) electric field resonance antennas 11, one of which is illustrated in FIG. 8, face each other as illustrated in FIG. 4. Moreover, components similar to those of the first embodiment are denoted by the same reference numerals.

As illustrated in FIG. 8, the electric field resonance antenna 11 according to the second embodiment includes a resonance unit 13 that resonates at a specific frequency, and a power supply unit 6 that inputs electric power to the resonance unit 13 or takes out electric power from the resonance unit 13 that resonates. The electric field resonance antenna 11 is a monopole-type electric field resonance antenna that generates a wave of an electric field by a single (one) spherical electrode 4 and a mirror image formed on a ground 10.

The resonance unit 13 mainly includes the spherical electrode 4, the ground (plate) 10, and a resonance coil 9. The resonance coil 9 is electrically connected with the spherical electrode 4 and the ground 10 and is located between the spherical electrode 4 and the ground 10.

The power supply unit 6 mainly includes a power supply coil 2 and a coaxial cable 8. The power supply coil 2 is magnetically coupled to the resonance coil 9 of the resonance unit 13 to input and output electric power to and from the resonance unit 13. The coaxial cable 8 is electrically connected with the power supply coil 2, and plays a role of causing a current to flow to the power supply coil 2 or causing a current from the power supply coil 2 to flow. A side (left side in FIG. 8) of the coaxial cable 8 opposite to the power supply coil 2 is electrically connected with a power transmission-reception circuit. That is, the power supply coil 2 of the power supply unit 6 is magnetically coupled to the resonance coil 9 of the resonance unit 13 to input and output electric power, and a ground 10 on the power supply unit 6 side is connected with the ground 10 of the resonance unit 13 to match the potential of the ground.

As in a general electric circuit, as the area of the ground 10 is larger, the potential of the ground 10 is less likely to fluctuate and is more stable. Therefore, it is desirable that the ground 10 has a large area.

Since the spherical electrode 4 and the ground 10 are made of a conductor, the spherical electrode 4 and the ground 10 can be made using a substrate in which a metal foil is attached to a dielectric or a metal plate.

As described above, effects similar to those of the first embodiment are also obtained in the case of using the monopole-type electric field resonance antenna 11 as illustrated in the second embodiment.

### Supplement

Each of the power transmission apparatuses of the embodiments can be utilized in the following situations by using electric field resonance antennas 1 or 11, for example.

(Case 1) Electric power is wirelessly transmitted from a desk to an electronic device placed on the desk to charge the electronic device.

(Case 2) Electric power is supplied from the ground surface to an electric vehicle that travels on a road.

(Case 3) Communication and authentication are performed by holding a contactless IC card over a reader of the card from the front.

In many cases, a direction in which a counterpart for power transmission or communication is placed is known in advance. A near-field resonance antenna that transmits power only toward the front direction where a counterpart exists and does not radiate power toward the back direction can achieve a wireless power transmission system or a contactless communication system that has high transmission efficiency, has little influence on external devices, and is less likely to receive interference from an external environment.

### REFERENCE SIGNS LIST

1 Electric field resonance antenna
2 Power supply coil
3 Resonance unit
4 Spherical electrode
5 Spherical electrode
6 Power supply unit
8 Coaxial cable
9 Resonance coil
10 Ground
11 Electric field resonance antenna
13 Resonance unit

1. An electric field resonance antenna comprising:
a resonator that includes a first spherical electrode, a second spherical electrode, and a resonance coil connecting the first spherical electrode and the second spherical electrode, and resonates at an output frequency of a power transmission-reception circuit for power transmission; and
a power supply that includes a power supply coil magnetically coupled to the resonance coil and electrically connected with the power transmission-reception circuit.

2. A power transmission apparatus comprising:
a pair of electric field resonance antennas of claim 1.

3. An electric field resonance antenna comprising:
a resonator that includes a spherical electrode, a ground, and a resonance coil connecting the spherical electrode and the ground, and resonates at an output frequency of a power transmission-reception circuit for power transmission; and
a power supply that includes a power supply coil magnetically coupled to the resonance coil and electrically connected with the power transmission-reception circuit,
wherein the resonance coil and the power supply coil are connected with the ground.

4. A power transmission apparatus comprising:
a pair of electric field resonance antennas of claim 3.
